(19) United States
(12) Patent Application Publication
(10) Pub. No.: US 2015/0088587 A1
(43) Pub. Date: Mar. 26, 2015

(54) METHOD FOR CHECKING THE AVAILABILITY OF THE COMPONENTS OF PRODUCTION AND/OR PACKAGING LINE

(71) Applicant: GEA Food Solutions Germany GmbH, Biedenkopf-Wallau (DE)

(72) Inventors: Nelson Moreira da Costa, Biedenkopf (DE); Jan Hennipman, Rosmalen (NL)

(21) Appl. No.: 14/387,631

(22) PCT Filed: Mar. 26, 2013
(86) PCT No.: PCT/EP2013/056375

§ 371 Date: Sep. 24, 2014

(30) Foreign Application Priority Data
Mar. 26, 2012 (DE) 102012005912.4

(51) Int. Cl. G06Q 10/06

(52) U.S. Cl. CPC G06Q 10/06315
USPC 705/7.25

(57) ABSTRACT

The present invention relates to a method for checking the availability of the components of a production and/or packaging line, wherein each component is connected to a computer means by a data transfer means.

The present invention relates to a method for checking the availability of the components of a production and/or packaging line, each component being connected to a computer means via a data transfer means.

The ability to check the availability of individual components, for example packaging machines, is known from the prior art. However, since these individual components are nowadays assembled more and more often as so-called lines, there is the need for a person skilled in the art to also be able to check the availability of the respective component within a line.

Therefore, the object of the present invention was to provide a method which can be used to check the availability of one and/or more components within a production and/or packaging line.

The object is achieved with a method for checking the availability of the components of a production and/or packaging line, each component being connected to a computer means via a data transfer means, wherein, in the event of a fault or operating state message relating to a component, the computer means checks whether this component or another component is the cause of the fault or operating state message.

The present invention relates to a method for checking the components of a production and/or packaging line. Such a production and/or packaging line is used in the food production industry, for example. This production and/or packaging line has a plurality of components. In the food processing industry, the lines first of all have, for example, at least one food processor: in particular
a defroster,
a food chopping means, for example a mincer and/or a cutter,
a mixer,
a shaper which shapes a food mass into particular individual portions having a particular shape and/or a particular weight,
a surface treatment means, for example a breadcrumb-coating apparatus,
a heat treatment means, for example an oven or a deep fryer, and/or
a slicer which divides a food product into a multiplicity of individual products, for example slices or cubes.

Furthermore, the production and/or packaging line, in particular in the food industry, also preferably has a portioned which is used to configure portions. For example, the port loner may divide a product stream into portions having a particular number of individual products and/or portions having a particular weight.

Alternatively or additionally, the production and/or packaging line preferably has a feeder and/or a packaging machine. The feeder feeds products or portions into packaging items. The feeder is, for example, an endless belt, in particular a so-called shuffle band, and/or a robot, in particular a so-called pick-and-place robot. The packaging machine may be any packaging machine familiar to a person skilled in the art. In particular, the packaging machine is a so-called form-fill-seal packaging machine, for example a so-called thermoformer or a vertical or horizontal tubular bag packaging machine. However, the packaging machine may also be a tray sealer.

A separator and/or a cartoner is/are also preferably provided downstream of the packaging machine. The separator separates the packaging items produced and the cartoner combines a particular number of packaging items in a carton.

According to the invention, each of those components is now connected to a computer means via a data transfer means. The data transfer means rosy be a data line or wireless data transmission. The data transfer is preferably bidirectional. The computer means is a conventional CPU which is known to a person skilled in the art and can also undertake control and/or regulation functions of the respective component and/or of the line, for example. This computer means is preferably provided in one of the components and is controlled via the input means, for example a display, of this component. Desired values, in particular desired production rates for the individual components and/or for the entire line, are preferably communicated to the computer means. The computer means preferably has an output means which can foe used to visualize the information obtained, for example, or to transmit it to another computer means. The computer means may be a plurality of units, in which case one computer means detects and possibly records only fault or operating state messages and a further computer means carries out the evaluation, for example.

The evaluation is preferably carried out with a time delay, in particular subsequently.

The computer means continuously receives fault or operating state messages relating to the respective component via this data transfer means. The operating state message comprises, for example, information relating to the production volume currently being produced by the respective component. Each item of information preferably contains a time indication, in particular a real-time indication. Furthermore, the operating state message may also contain, for example, information relating to the stock of a consumable which is still available. A fault message comprises, for example, information stating that the respective component is not producing or is producing at a reduced production rate.

As soon, as an operating state message, which signals to the computer means that the respective component is producing at a reduced capacity, arrives at the computer means and/or a fault message, which relates to the respective component and signals to the computer means that the respective component is at a standstill, arrives at the computer means, the computer means checks the reason for the operating state, that is to say whether the reduced capacity and/or the standstill of the respective component was/were actually caused by this component.

For this purpose, the respective component can provide the computer means with further information, for example, in order to determine whether a mechanical and/or electrical/electronic fault has occurred in the respective component. For example, each component has at least one sensor which communicates information relating to the mechanical and/or electrical/electronic state of the component and/or relating to the availability of operating means and/or raw materials to the computer means. A means which also checks the functionality of the sensor is particularly preferably also additionally provided. If a sensor informs the computer means, for example, that an operating means and/or a raw material is/are not available, the computer means first of ail checks whether this sensor is functional in order to determine whether the operating means and/or the raw material is/are actually missing or the sensor is defective. Only when the computer means has determined that the respective operating means and/or the raw material is/are actually missing will it assign the reduction in production to the supply of raw material or the replenishment of operating means using the available information.

Alternatively or additionally, the computer means checks the operating state of the other components in the line and in the process determines whether said components are producing according to the predefined production rates, if this is not the case, the computer means checks the temporal sequence in which the respectively reduced production capacities were reported to the computer means by the respective component. In particular, in this context, the computer means checks whether a reduced production capacity of a component is only a response to a reduced production capacity of an upstream or downstream component. In this manner, the computer means determines which component is the cause of the reduction in the production capacity of the line.

The computer means then assigns this reduction in the production capacity only to this individual component since the other components in the line must reduce their production capacity only in response to the component which causes the fault. In this manner, the computer means can determine production bottlenecks.

On the basis of this information, the computer means then preferably creates a performance analysis for the line, in which it is determined which component is most frequently responsible for a reduction in the production capacity. This component is then preferably analyzed by the computer means in more detail in order to determine the reasons for failure. For example, the failure may be caused by the machine or replenishment. A failure caused by the machine may be rectified, for example, by means of more frequent or more targeted, maintenance, by means of a component with a higher capacity and/or by providing a parallel additional component in the line. A failure caused by replenishment can be at least alleviated by means of improved production logistics.

The computer means preferably also detects why the production capacity of this component had to be reduced and/or for how long the causative component produced at a reduced capacity. The maintenance and/or consumables replacement strategy of the line, for example, can be optimized on the basis of this information.

At least, one component in the line is preferably provided in a multitrack and parallel manner. Each of these parallel components is separately connected, by means of a data transfer means, to the computer means which preferably separately receives information from all parallel components relating to their availability and/or their production capacity.

Furthermore, the computer means preferably also detects components and/or combinable groups of components which are provided downstream, and/or upstream, of the line and can each be analyzed only as a group or as a group of downstream, components and/or a second group of upstream components and/or further definable groups, the number of which depends on the number of data transfer means.

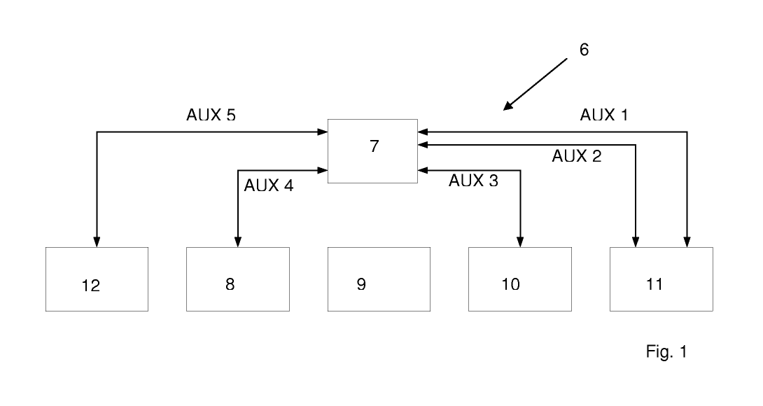

The invention is explained below using the single FIG. 1. These explanations are only exemplary and do not restrict the general concept of the invention.

FIG. 1 shows a production and/or packaging line 6 which, in the present case, is used in the food industry. Beginning from the right, this line 6 has a slicer 11 with a product supply area. Downstream of the slicer 11 is a product feeder 10 which is used to feed products into packaging depressions which have been deep-drawn in a packaging machine 9. The packaging machine is a so-called form-fill-seal packaging apparatus (FFS packaging machine). As soon as the packaging depressions have been filled with the respective product, they are sealed with a covering film. Downstream of the packaging machine 9 is also a separator 8 which separates the finished packaging items, with the result that they can then be packaged into cartons, for example. Each of these components 8-11 is connected, to a computer means 7 by means of at least one data transfer means AUX1-S. The data transfer means AUX1-5 map each be one of the data lines or a wireless connection. The computer means 7 has at least one CPU. The computer means 7 also preferably has an input means (not illustrated) which can be used to transmit desired values of the production capacity of the respective component or the line to the computer means, for example. The computer means 7 preferably also has an output means (not illustrated) which can be used to transfer calculated analysis results to a display, to a printer and/or to a further computer means. The computer means 7 is preferably part of one of the components 8-11 ox of a central controller of the components 8-11. If the computer means is now informed, via the data transfer means AUX 3, that the loader 10 is operating at a reduced capacity or is not operating at all, the computer means 7 checks whether a stop signal has teen transmitted to the loader 10 by the packaging machine 9, for example, and/or whether no food slices have been delivered to the loader 10 by the slicer 11, for example. If the latter is the case, for example, the computer means knows that the loader 10 is not the cause of its reduction in production or even production stop, but rather that the slicer 11 does not provide any further food slices. The computer means 7 then checks whether the slicer 11 applies a fault message indicating a mechanical and/or electrical/electronic fault in the slicer or whether no products to be sliced are available to the slicer. If there is a fault in the slicer, the standstill or the reduction in production of the line is attributed to this component. If no products are available to the slicer, the computer means analyzes whether the product sensor, which communicates with the computer means via the data transfer line AUX 1, is operating properly. If this is the case, the computer means 7 records the fact that the product replenishment to the line 6 is not operating and that none of the components is the cause of the reduction in production. If the sensor at the product inlet of the slicer is not operating properly, the fault is assigned to the slicer, for example.

In a sophisticated analysis, the computer means resorts, for example, to data relating to when the slicer was last maintained and whether the sensor was checked as part of this maintenance, for example. If this is not the case, the computer means generates an improvement proposal to the effect that the sensor should be concomitantly checked during the next maintenance.

On the basis of the above-mentioned analysis, the computer means can preferably determine which component in the line is substantially the cause of a reduction in the production of the line and whether this is due to apparatus faults or to product supply deficiencies. On the basis thereof, the computer means preferably creates proposals for how these bottlenecks can be removed.

In a farther analysis, the computer means furthermore also detects components and/or combinable groups of components which are provided downstream and/or upstream of the line and can each be analyzed only as a group or as a group of downstream components and/or a second group of upstream components and/or further definable groups, the number of which depends on the number of data transfer means AUX. For example, a downstream group of components can be analyzed using the data transfer means AUX 5.

List of Reference Symbols:

Aux 1 Product sensor data transfer line

Aux 2 Slicer data transfer line

Aux 3 Loader data transfer line

Aux 4 Package separation data transfer line

Aux 5 Line end data transfer line

6 Production/packaging fine

7 Computer means

8 Separator

9 Packaging machine

10 Loader

11 Food processor, slicer

12 Line end, group of components

What is claimed is:

1. A method for checking the availability of the components of a production and packaging line, consisting of:
at least a food processor component,
a loader component, and
a packaging machine component and a separator component, each component being connected to a computer means via a data transfer means,
wherein in the event of a fault or operating state message relating to a component, the computer means checks whether this component or another component is the cause of the fault or operating state message.

2. The method as claimed in claim 1, wherein the operating states of the individual components are continuously defected by the computer means.

3. The method as claimed in claim 1, wherein the temporal sequence of fault and/or operating state messages relating to the individual components is detected.

4. The method as claimed in claim 1, wherein the fault message relating to the respective component comprises an item of information relating to the reason for failure.

5. The method as claimed in claim 1, wherein the operating state message relating to the respective component comprises an item of information relating to the reason for the operating state.

6. The method as claimed in claim 3, characterized in that maintenance intervals are initiated and/or controlled on the basis of the reason for failure.

7. The method as claimed in claim 1, wherein the computer means detects the period of time over which the respective component was not available.

8. The method as claimed in claim 1, wherein the computer means determines the performance of the individual component and of the production and/or packaging line on the basis of the operating state messages and/or the fault messages.

9. The method as claimed in claim 8, characterized in that the bottleneck in the production and/or packaging line is determined.

10. The method as claimed in claim 1, wherein at least one component is provided in a multitrack and parallel manner.

11. The method as claimed in claim 10, wherein the fault or operating state message relating to each parallel component is individually detected and evaluated.

12. The method as claimed in claim 1, wherein at least one component and/or one group of components is provided downstream and/or upstream and is detected and evaluated as a group.

13. The method as claimed in claim 2, wherein the fault message relating to the respective component comprises an item of information relating to the reason for failure.

14. The method as claimed in claim 2, wherein the operating state message relating to the respective component comprises an item of information relating to the reason for the operating state.

15. The method as claimed in claim 13, wherein the operating state message relating to the respective component comprises an item of information relating to the reason for the operating state.

16. The method as claimed in claim 6, wherein the computer means detects the period of time over which the respective component was not available.

17. The method as claimed in claim 15 wherein the computer means detects the period of time over which the respective component was not available.

18. The method as claimed in claim 17, wherein the computer means determines the performance of the individual component and of the production and/or packaging tine on the basis of the operating state messages and/or the fault messages.

19. The method as claimed in claim 17, wherein at least one component is provided in a multitrack and parallel manner.

20. The method as claimed in claim 17, wherein at least one component and/or one group of components is provided downstream and/or upstream and is detected and evaluated as a group.
